(19) United States
(12) Patent Application Publication
(10) Pub. No.: US 2010/0194120 A1
(43) Pub. Date: Aug. 5, 2010

(54) CLOSURE FOR VEHICLES

(76) Inventors: Hans-Günter Kaiser, Wuppertal (DE); Artur Torka, Hattingen (DE)

Correspondence Address: Horst M. Kasper, 13 Forest Drive, Warren, NJ, 07059, US

(21) Appl. No.: 12/451,769

(22) PCT Filed: Apr. 11, 2008
(86) PCT No.: PCT/EP2008/003082

§ 371 Date: Nov. 27, 2009

(30) Foreign Application Priority Data
May 30, 2007 (DE) 10 2007 025 309.7
Oct. 24, 2007 (DE) 10 2007 050 672.6

(51) Int. Cl. E05C 3/06

(52) U.S. Cl. 292/198

(57) ABSTRACT

The invention relates to a closure in which a lock interacts with a closing element (10). The lock comprises a stationary, rotationally mounted (14) catch (15) that can be pivoted between an open position (15.1), a preliminary locking position (15.2) and a main locking position (15.3). The lock also comprises a pawl (30) and several sensors (51-53) that monitor various working positions of the lock element. In order to improve the control of the lock, the rotary catch (15) is associated with two separate pawls (20, 30), one of said pawls acting as preliminary catch pawl (20) and only engages with the preliminary catch element (17), whilst the other pawl acts as the main catch pawl (30) and only engages with the main catch element (18). Two sensors (51, 52) are provided, one of which (52) engages directly or indirectly with the main catch pawl (30) and the other (51) engages directly or indirectly with the preliminary catch pawl (20) and monitors the catch engagement position (20.2, 30.2) and/or release position (20.1, 30.1).

The invention relates to a closure of the kind indicated in the preamble of claim 1, wherein the lock of the closure includes a rotary supported catch and a swivel supported blocking pawl. The rotary catch is transferred by the locking element from its open position initially into a preliminary lock position upon closing of the door, which preliminary lock position is secured by the blocking pawl. Then the rotary catch is rotated further into a main catch position either manually or by motor, wherein the main catch position is also secured by the blocking pawl. Sensors are to monitor various work positions of the lock members.

The German printed Patent document DE 10327997 A1 shows a known closure of this kind, wherein the further rotation of the rotary catch from its preliminary catch position into the main catch position is effected by a motor. The lock of this known closure employs only one pawl, which falls either into a preliminary catch or into a main catch of the rotary catch. A closure help is employed for further rotation of the rotary catch by motor, wherein the closure help drives a pair of toggle levers through a motor driven, eccentric cam, wherein a spring supported carrier engages a free end of the pair of toggle levers. The toggle lever pair is spatially fixed supported on one end and is restrained guided by guiding means on the other end. The closure motion is produced by a stretching or buckling of the toggle lever pair. This closure help requires a substantial space.

The respective working position of the lock members could not always be reliably determined with known closures of the kind indicated in the preamble of claim 1. A control apparatus does not know exactly in which phase of the working motion the lock member monitored by the sensor is disposed. This renders an exact control of the lock difficult.

It is an object of the present invention to better monitor the respective work position of the lock member and to evaluate the respective work position more reliably. This is accomplished by the steps recited in claim 1, wherein the steps have the following particular meaning.

The precise determination of the respective working position of the rotary catch is important for a lock. For example, one may wish to determine unequivocally, if the rotary catch is precisely still in its preliminary locking position or already in the main locking position. The present invention proposes for this purpose initially two separate blocking pawls, wherein the first pawl of the two pawls engages only at the preliminary snap in and therefore is called in the following “preliminary catch pawl”. The second blocking pawl is disposed separate from the preliminary catch pawl and engages only at the main snap in and is therefore called “main catch pawl”. One of the two sensors monitors immediately or indirectly the main catch pawl in order to determine, if the main catch pawl is in its engagement position or in its release position relative to the main snap in of the rotary catch. Therefore this first sensor is called “main lock sensor”. In contrast, the second sensor determines immediately or indirectly over one or several intermediate members the engagement position and the release position of the preliminary catch pawl at the preliminary snap in of the rotary catch and therefore operates as “preliminary lock sensor”. It is most simple where the sensor performs the monitoring immediately at the respective pawl. Alternatively, an indirect monitoring of the respective pawl through one or several intermediate members is also possible, wherein for example a control lever is disposed between the sensor and its pawl.

Further steps and advantages of the invention result from the sub claims, the following description and the drawings. An embodiment example of the invention is presented in different working positions in the drawings, and in fact by way of a lock which is mounted at a rear flap of a vehicle, while the associated closure element is disposed at a spatially fixed part of the vehicle body. There is shown in:

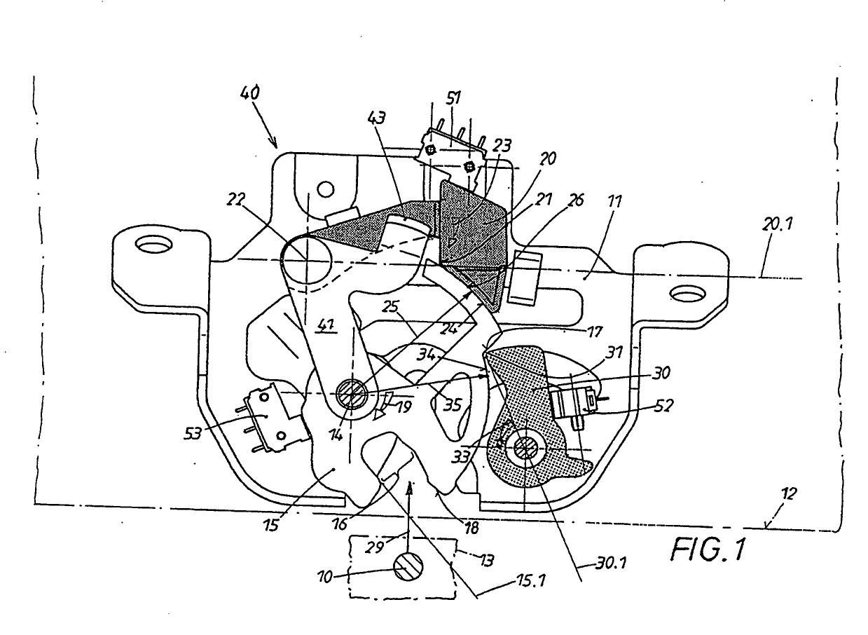

FIG. 1 the situation with opened rear flap of a vehicle, wherein a rotary catch of the lock is present in its open position,

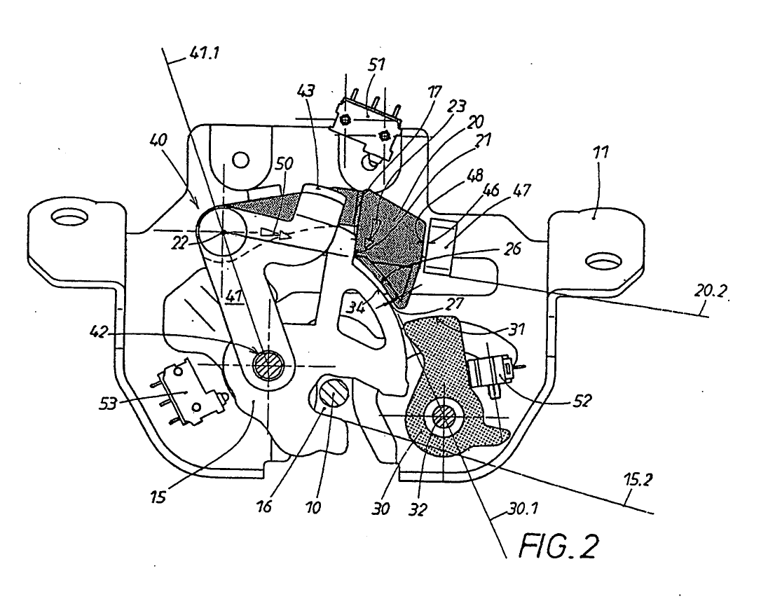

FIG. 2 the same lock with half closed flap, wherein the rotary catch assumes a preliminary locking position,

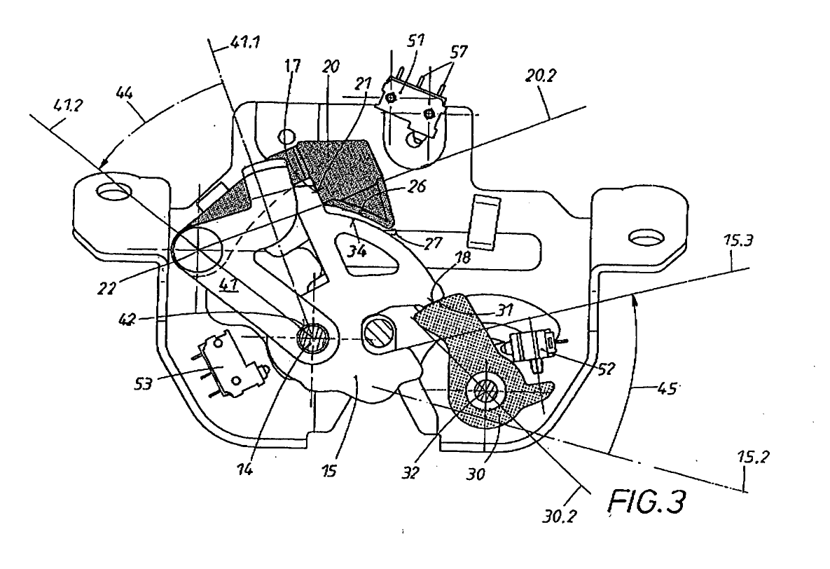

FIG. 3 the closing phase of a closing process of the rotary catch by way of a motor driven closure help, wherein the rotary catch is in the transition from a preliminary locking position into a main locking position, which just has been accomplished,

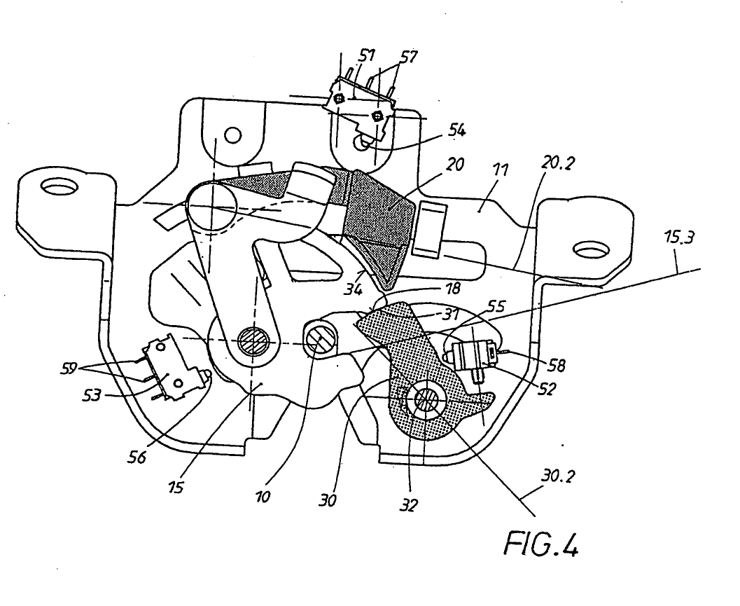

FIG. 4 the lock with fully closed flap, after the device components of the closure help have moved back into their starting position in the main lock position of the rotary catch,

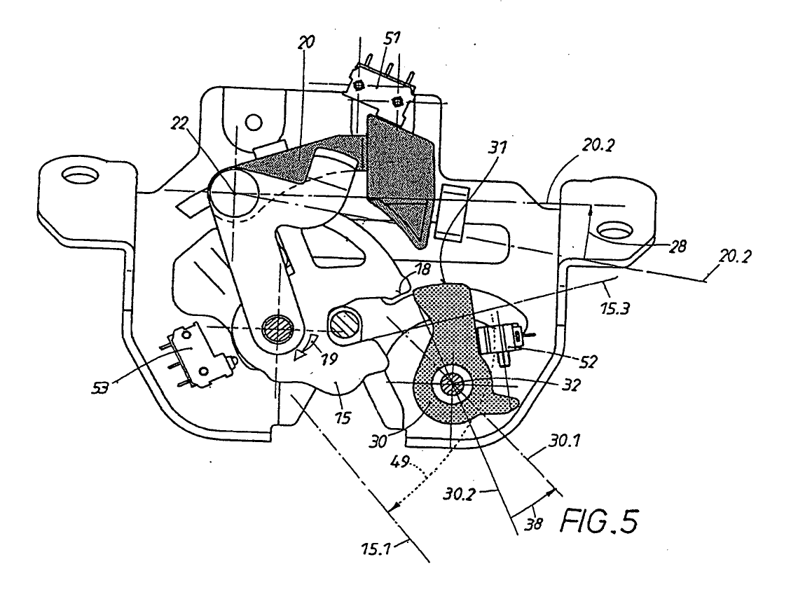

FIG. 5 the initial face of an opening motion, where the two pawls have released the rotary catch by way of a not in detail shown release member with the purpose that the rotary catch can move from its main lock position with fully closed flap into its open position with an opened flap,

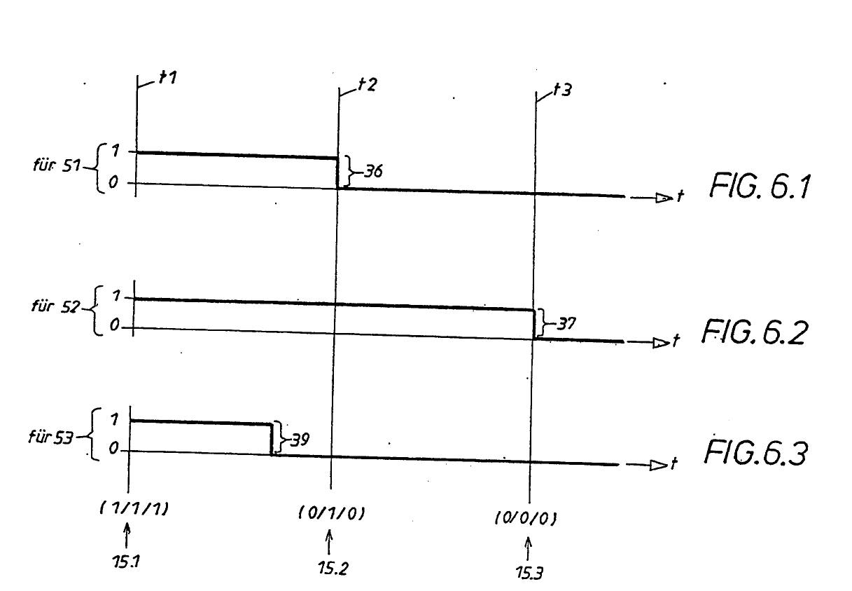

FIGS. 6.1 to 6.3 three diagrams with coinciding position of the horizontal time axis, wherein the digital switching signals of three sensors have been entered, and wherein the three sensors deliver a code of three signals to a not in detail shown electrical control apparatus at each point in time, wherein the electrical control apparatus determines the respective working position of the lock members from the code.

In the present case, the closure comprises a lock, which lock is attached to a tailgate 12 of a vehicle indicated in FIG. 1 with dash-dotted lines with its lock housing 11 shown opened in the figures. A closure element 10 cooperating with the lock is indicated spatially fixed to a vehicle body 13 illustrated also with dash-dotted lines in FIG. 1. The closure element 10 can be formed out of one bow leg of a U-shaped element or out of a bolt.

The figures show only the most essential device components required for an understanding of the invention. A rotary catch 15 is initially associated with the most essential device components, wherein the rotary catch is supported at a rotary axis 14 spatially fixed to the lock housing 11. The rotary catch initially has a receiver slot 16 for the closure element 10 and two shoulders 17, 18 disposed at a distance at the contour profile of the rotary catch, wherein the shoulders 17, 18 operate as preliminary snap in 17 and as main snap in 18. The rotary catch 15 can assume different rotary positions in the different work phases of the lock, which rotary positions are illustrated in the drawings.

The rotary catch 15 is disposed in FIG. 1 in an open position marked up with an auxiliary line 15.1. Then the flap is fully opened. The rotary catch 15 is loaded by a spring force not shown here in detail, wherein the spring force strives to hold the rotary catch 15 in the sense of the arrow 19 of FIG. 1 pressed against a limit stop not shown in detail. The open position of the rotary catch 15 is determined by an auxiliary line 15.1 through the force loading 19 and the limit stop.

A relative motion between the lock housing 11 and the closure element 10 occurs upon closing the flap, wherein the relative motion is illustrated in FIG. 1 by way of the motion arrow 29. Upon closure 29, the closure element 10 encounters a flank of the receiver slot 16 and thereby rotates the rotary catch 15 out of its open position 15.1 into a preliminary locking position, wherein the preliminary locking position is illustrated in FIG. 2 by an auxiliary line 15.2. The rotary catch 15 is rotated against its force loading 19. The closure element 10 is already captive in the receiver slot 16 of the rotary catch 15. The preliminary lock position 15.2 is held fast through a first pawl 20 as shown in FIG. 2. This pawl 20 grips behind the already described preliminary snap in 17 of the rotary catch 15 with a locking position 21. Therefore the pawl 20 is to be designated as “preliminary catch pawl” as already initially mentioned.

The preliminary catch pawl 20 supports itself with a support face 26 in the open position 15.1 recognizable from FIG. 1, wherein the support face 26 leads the radial positioned support position 21 at a circumferential support face 24 of the rotary catch 15. This support 26, 24 is planar as seen in FIG. 1. The rest support face 24 has a large radius of curvature 25 relative to the rotation axis 14 of the rotary catch 15. The support at 26, 24 is generated, since also the preliminary catch pawl 20 is subject to a spring loading, wherein the spring loading is illustrated in FIG. 1 by the force arrow 23. The preliminary catch pawl 20 is supported at a special movable swivel axis 22 in the present case, which will be described below in more detail. The pawl support face 26 is disposed in a radial distance to the catch support face 34 in the preliminary catch position 15.2 as shown in FIG. 2; there remains there a slot 27.

Starting with the preliminary lock position 15.2 of FIG. 2, the rotary catch 15 can be transferred either through further manual pressing toward closure of the tailgate 12 or by motor, as in the illustrated embodiment example into a main catch position illustrated by the auxiliary line 15.3 of FIGS. 3 and 4. Then the tailgate 12 is fully closed. The closure element has then penetrated still deeper into the lock housing 11 and is retained particularly reliable by the rotary catch 15. The main lock position 15.3 is secured by a second pawl 30, wherein the second pawl 30 is supported by a spatially fixed swivel axis 32 in the lock housing 11. The pawl 30 is supported with the blocking position 31 at the described main snap in 18 of the rotary catch 15. Therefore, as mentioned above, the pawl 30 is to be designated as “main catch pawl”.

The main catch pawl 30 supports itself at a second circumferential rest support face 34 of the rotary catch 15 in the open position 15.1 of FIG. 1, wherein the second circumferential rest support face 34 has a smaller radius of curvature 35 than the previously described first rest support face 24 relative to the rotation axis 14 of the rotary catch 15. The main catch pawl 30 is subject to a spring loading illustrated by the force arrow 33 in FIG. 1. This spring loading 33 takes care that during the above described rotation of the rotary catch 15, the blocking position 31 at the end of its peripheral rest face 34 falls in behind the main snap in 18 as shown in FIG. 2.

As already mentioned, the further rotation of the rotary catch from the preliminary lock position 15.2 in FIG. 2 into the main lock position 15.3 of FIGS. 3 and 4, that is by a closure help illustrated in fact in summary fashion through the reference character 40 in FIG. 2, wherein only the last work member 41 on the lock side is shown of the closure help. The work member 41 comprises in the present case a lever 41, which is rotation supported spatially fixed at 42 in the lock housing 11. The spatially fixed rotary support 42 of the work lever 41 coincides with the above described rotation axis 14 of the catch 14 (translators remark: should be 15). The rotary bearing 42 is an axial extension of the rotation axis 14.

The work lever 41 can have a course with an angle. Drive means of the closure help 40 not shown in detail engage and grip at the free end 43 of the work lever 41. A peculiarity of the invention comprises that the already mentioned swivel axis 22 of the preliminary catch pawl 20 is seated at the work lever 41 and therefore the swivel axis 22 moves together with the work motion of the lever 41. This co-motion can be recognized from the transition of the rotary catch 15 from FIG. 2 to FIG. 3, wherein the FIG. 3 shows the last phase of this co-motion. The working lever 41 is disposed according to FIG. 2 still in its starting position illustrated by the auxiliary line 41.1. The working lever 41 is further rotated around its rotation bearing 42 up to its final position recognizable in FIG. 3, wherein the final position is illustrated in FIG. 3 by an auxiliary line 41.2. The extent of the rotation can be recognized in FIG. 3 with the rotary arrow 44.

This rotation 44 effects that the rotary catch 15 is further rotated by a corresponding angle amount 45 around its rotation axis 14. The final state of the closure motion, that is the main lock position 15.3 of the rotary catch 15, where the blocking position 31 of the rotary catch 15 already has fallen in behind the main catch 18 as shown in FIG. 3 and as already mentioned. The drive means on the lock side for the rotation 45 of the catch 15 are the same as those which provide for their above described preliminary lock position 15.2 in FIG. 2, in fact the preliminary catch pawl 20 and its swivel axis 22 at the working member 41. The preliminary catch pawl 20 therefore has the further function to be at the same time drive means of the closing help 40. The blocking position 21 of the preliminary catch pawl 20 is in engagement with the preliminary snap in 23 of the rotary catch 15 from FIG. 2 up to FIG. 3. During further rotation 45 of the rotary catch 15 thus the two functions are not only active with the same device components, but also with the same engagement means 21, 23.

The different working positions of the lock members are monitored and controlled through a control apparatus, wherein the control apparatus cooperates with several sensors 51 through 53. At least two sensors 51, 52 are furnished and the first sensor 51 monitors the preliminary catch pawl 20 and the other sensor 52 monitors the main catch pawl 30. The monitoring of the two pawls 20, 30 can be performed either directly, as illustrated in the embodiment example, or indirectly, for example through a transfer lever not shown in detail. The sensor 51 monitors if, relative to the swivel axis 22, the preliminary catch pawl 20 is disposed in its release position 20.1 of FIG. 1 or in its fall in position illustrated by the auxiliary line 20.2. A corresponding relation holds for the second sensor 52. The sensor 52 determines if, relative to the swivel axis 32 of the main catch pawl 30, the main catch pawl 30 is placed in its release position 30.1 relative to the rotary catch main snap in 18 according to FIGS. 1 and 2 or in its fall in position 30.2 according to FIGS. 3 and 4, wherein the rotary catch 15 is supported at the main snap in 18.

The present embodiment example has still a third sensor 53, wherein the third sensor 53 monitors analogously directly or indirectly the rotation position of the rotary catch 15. According to the embodiment example the sensor 53 engages immediately at the rotary catch 15 and monitors, if the rotary catch 15 is placed in the open position 15.1 of FIG. 1 or in the main lock position 15.3 of FIG. 3 or FIG. 4. It is understood that if required alternatingly or additionally also still other rotary positions of the rotary catch 15 could be monitored, for example the preliminary lock position 15.2. However, this can be dispensed with in the present embodiment example, because this monitoring, as was mentioned above, is performed by the first sensor 51.

The three sensors 51 to 53 comprise electrical micro switches in the present situation, wherein the electrical micro switches in each case exhibit a switching member 54 through 56 recognizable in FIG. 4. The switching members 54 through 56 strive based on internal spring loading to pass into their drawn out projection position visible in FIG. 4, wherein the drawn out projection position corresponds in each case to one of their switch off positions. The sensors 51 through 53 are connected to the already mentioned electrical control apparatus through respective connections 57 through 59. The control apparatus receives from all three sensors 51, 53 in each case a switch off signal “zero” in the lock position of FIG. 4. If one writes the signals received by the sensors 51 through 53 in the main lock position as a digital code at the control apparatus, then this digital code reads 0/0/0. The control apparatus determines therefore over this code that the preliminary catch 20 is disposed in the fall in position 20.2 ready to engage, further the main catch pawl 30 is disposed in its effective fall in position 30.2 and finally the rotary catch 15 is disposed in its main catch position 15.3.

The signals coming from the three sensors 51 through 53 in the positions 15.1, 15.2, and 15.3 are illustrated in three diagrams of FIGS. 6.1 through 6.3. FIG. 6.1 shows the signals occurring at the associated connection 57 of the first sensor 51. The corresponding holds for FIG. 6.2, wherein FIG. 6.2 presents the diagram of the second sensor 52, as well as also for FIG. 6.3, wherein FIG. 6.3 represents the diagram of the third sensor 53. The abscissas of the three diagrams are the time scale, which time scales are aligned to each other in the starting point in time as is shown by the timeline t₁. The three ordinates of the FIGS. 6.1 through 6.3 show the two alternative switching signals, which switching signals occur at their previously recited connections 57 through 59, that is in fact either the switch on signal 1 or the switch off signal 0. The connecting line t₁ shows the point in time of the open position 15.1 of the rotary catch. It can be recognized from this line t₁ that a digital code 1/1/1 holds for the three sensors 51 through 53 in the open position 15.1 of the rotary catch.

The second sensor 52 remains active upon transition from the open position of FIG. 1 into the preliminary lock position 15.2 of FIG. 2, while the two other sensors 51, 53 report a switch off signal to the control apparatus. The preliminary lock position 15.2 thus can be represented by the digital code 0/1/0. FIG. 2 shows relative to FIG. 1 exactly that rotary position of the catch 15, wherein the preliminary catch pawl 20 with its blocking position 21 just fell in into the preliminary snap in 17. The electrical control apparatus thus determines the preliminary lock position 15.2 of the rotary catch at the transition 36 recognizable in FIG. 6.1 between the code 1/1/1 to the code 0/1/0. This transition 36 can be determined very precisely. This results from the line t₂ in the diagrams of FIGS. 6.1 through 6.3.

The three sensors 51 to 53 in the main lock position 15.3 of FIGS. 3 and 4 deliver the electrical signals 0/0/0 to the electrical control apparatus as was already mentioned above. The exact point t₃ in time can also be recognized by the control apparatus by having the second sensor 52 just switch from the switch on signal 1 to the switch off signal 0. This transition at the point t₃ in time has just been completed in the diagram of FIG. 6.2. The control apparatus registers this code change marked with 37 in the FIG. 6.2. It is important that the signal 0 of the preliminary catch sensor 51, which occurs in the preliminary lock position 15.2 of the rotary catch 15, does not change upon further rotating of the rotary catch 15 up to the main lock position 15.3. The signal 0 remains.

If required also the code change marked with 39 in FIG. 6.3 could be monitored at the third sensor 53. This however is not employed in the present situation. The third sensor 53 operates in fact as a so-called “snow load sensor”, which snow load sensor has to determine if the open position 15.1 of the lock of FIG. 1 is present or not. In fact, a snow load could take care of that the rotary catch 15 even then remains in its main lock position 15.3 through the snow load weight, while the associated main catch pawl 30 has released its main snap in 18 and while the tailgate 12 is completely closed. The rotary catch 15 is pressed onto the closure element 10 in this case.

FIG. 5 shows the initial phase during opening of the fully closed rear flap, wherein the rotary catch 15 just is still present in its main lock position 15.3, even though the associated pawl 30 with its blocking position 31 has already released the catch main snap in 18. A common release lever, not shown in detail, can serve for this purpose, wherein the release lever moves back the main catch pawl 30 as well as also be preliminary catch pawl 20 in the sense of the swivel arrows 28 or, respectively, 38 drawn in FIG. 5 from their fall in positions 20.2 or, respectively, 30.2 into their respective release position 20.1 or, respectively, 30.1. Then the rotary catch 15 is free of both pawls 20, 30 and can be turned back up to its open position 15.1 illustrated dash-dotted in FIG. 5 based on the mentioned force loading 19 of the rotary catch 15. This turning and rotating back of the catch 15 is illustrated with a dotted rotary arrow 49 in FIG. 5.

The previously mentioned common release member for the two pawls 30, 20 could be seated at the bolt of the swivel axis 32 of the main catch pawl 30 and could be formed as a common release lever. This release lever then has two positions of effect, which positions of effect operate onto the two pawls 20, 30 in the sense of the described swivel actuations 28, 38. It is understood that alternatively also two separate release members could be employed. A common release member, which engages only at one pawl, for example the main catch pawl 30, could then also be employed for the described release actuations 28, 38 as long as the one pawl, for example the main catch pawl 30, overlaps at certain points the other pawl, which pawl would then be the side catch pawl 20. Based on the overlapping, thus the motion of the one pawl 30 is transferred onto the other pawl 20.

The release member not shown in detail here, can be manually actuated in the present situation, for example through a handle furnished at the tailgate. This could however also be performed with a motor, through a so-called “opening help”. For this purpose of the two pawls 20, 30 are swivelled by motor action in the sense of the release arrows 28 or, respectively, 38 as shown in FIG. 5. The release member participating at this lifting out 28, 38 would then be the motor release member driven by the motor.

The limit stop 46 is coordinated to the preliminary catch pawl 20 as shown in FIG. 2, wherein the limit stop 46 is formed by a block 47 disposed spatially fixed in the lock housing 11. This limit stop 46 is disposed at a short distance from the front end 48 of the preliminary catch pawl 20. If a crash should occur at this preliminary lock position 15.2 recognizable from FIG. 2, then the pawl 20 can find support at the limit stop 46. Crash forces illustrated in FIG. 2 act and operate in the sense of the force arrow 50 based on the engagement of the lock element 10 with the rotary catch 15, wherein the crash forces can be transferred by the preliminary catch pawl 20 over the faces 48, 46 onto the spatially fixed block 47. These crash forces 50 act and operate essentially in the longitudinal direction of the preliminary catch pawl 20 and are deflected onto the lock housing 21 and therewith onto the tailgate 12 through the block 47. This way one obtains a high crash safety without having to take care of a correspondingly large strength of the lock parts, which is noticed by way of small dimensions, by the saving in weight, and by small space requirements.

The main catch pawl 30 is positioned in an opposite sense to the preliminary catch pawl 20. The main catch pawl 30 is pressure loaded in the main lock position 15.3 because the rotary catch 15 with its main snap in 18 supports itself at the blocking position 31 as shown in FIG. 4. The support force is transferred in the longitudinal direction of the main catch pawl 30 to the swivel axis 32 of the main catch pawl 30. In contrast the preliminary catch pawl 20 is tension loaded in the preliminary lock position 15.2 of the rotary catch 15 as can be recognized from FIG. 2. The blocking position 21 of the preliminary catch pawl 20 grips behind the preliminary snap in 17 of the rotary catch 15. The two pawls 30, 20 are turned towards each other with their free ends exhibiting the respective blocking position 21, 31 and are turned away from each other with their swivel axes 22, 32.

Finally it is possible to employ the lock according to the present invention in two different applications. The one application would be a comfortable servo lock, wherein the locking help described above is integrated. The other application would be a simplified standard lock, which is used without the locking help 40. Then the described work lever 41 would be left out in the presented embodiment example in case of such a standard lock as well as together with its motor drive. Since one dispenses with the preliminary snap in 17 at such a standard lock, then also the preliminary catch pawl 20 can be dispensed with. In fact only the main snap in 18 is employed in connection with a standard lock. The rotary catch 15 and the main catch pawl 30, possibly with one or with two associated sensors 52, 53 remain as device components in the standard lock. A change of the device components 15, 30 can be dispensed with in a standard lock. The simultaneous use in the standard lock and in a servo lock allows producing these device components in very large series numbers, which is noticed in low production costs.

### LIST OF REFERENCE CHARACTERS

10 closure element
11 lock housing
12 rear flap
13 vehicle body
14 rotary axis for 15
15 rotary catch, catch
15.1 open position of 15 (FIG. 1)
15.2 preliminary locking position of 15 (FIG. 2)
15.3 main locking position of 15 (FIG. 4)
16 receiver slot in 15 for 10
17 preliminary snap in at 15
18 main snap in at 15
19 force load arrow of 15 (FIG. 1)
20 first pawl, preliminary catch pawl
20.1 release position of 20 (FIG. 1)
20.2 fall in position of 20 (FIG. 2)
21 blocking position of 20
22 movable swivel axis of 20 (FIG. 1)
23 force arrow of the spring loading (FIG. 1)
24 first peripheral and circumferential rest face of 15 (FIG. 1)
25 radius of curvature of 24 (FIG. 1)
26 support face at 20 for 24 (FIG. 1)
27 slot between 34, 26 (FIGS. 2, 3)
28 swivel arrow of 20 (FIG. 5)
29 arrow of the relative motion of 10 relative to 12 (FIG. 1)
30 second pawl, main catch pawl (FIG. 1)
30.1 release position of 30 (FIGS. 1, 2)
30.2 fall in position of 30 (FIGS. 3, 4)
31 blocking position of 30
32 spatially fixed swivel axis for 30 (FIG. 4)
33 force arrow of the spring loading of 30 (FIG. 1)
34 second circumferential rest face at 15 (FIG. 1)
35 radius of curvature of 34 (FIG. 1)
36 code change at t₂ (FIG. 6.1)
37 code change at t₃ (FIG. 6.2)
38 swivel arrow of 30 (FIG. 5)
39 code change (FIG. 6.3)
40 closing help for 15 (FIGS. 1, 2)
41 work member of 40, work lever (FIG. 2)
41.1 starting position of 41 (FIG. 2)
41.2 finally position of 41 (FIG. 3)
42 spatially fixed rotary bearing for 41 (FIG. 2)
43 the arm end of 41 (FIGS. 1, 2)
44 rotary arrow of 41 (FIG. 3)
45 rotary arrow, further rotation of 15 (FIG. 3)
46 limit stop of 47 for 20 (FIG. 2)
47 block for 47 (translators remark: should be 46) (FIG. 2)
48 front end of 20 (FIG. 2)
49 dotted rotary arrow for 15 (FIG. 5)
50 force arrow during crash between 20, 46 (FIG. 2)
51 first sensor for 20, preliminary catch sensor
52 second sensor for 30, main catch sensor
53 third sensor for 15
54 switch member for 51 (FIG. 4)
55 switch member for 52 (FIG. 4)
56 switch member for 53 (FIG. 4)
57 connector at 51 for control apparatus (FIG. 4)
58 connector at 52 for control apparatus (FIG. 4)
59 connector at 53 for control apparatus (FIG. 4)
0 switch off position of the sensors 51 through 53 (FIG. 6.1 through 6.3)
1 turned on position of the sensors 51 through 53 (FIG. 6.1 through 6.3)
t time scale (FIG. 6.1 through FIG. 6.3)
t₁ point in time line t₁ for 15.1 (FIG. 6.1 through 6.3)
t₂ point in time line t₁ for 15.2 (FIG. 6.1 through 6.3)
t₃ point in time line t₁ for 15.3 (FIG. 6.1 through 6.3)

1. Closure between a resting part of a vehicle such as a vehicle body (13) and a movable part of a vehicle such as a door or flap (12) at the vehicle,
with the closure element (10) at the one part, such as the vehicle body (13), and with a lock out of several lock members at the other part, as the rear flap (12),
wherein the one lock member is a spatially fixed, rotary supported (14) catch (15), wherein the rotary supported (14) catch (15) includes a preliminary snap in (17) and a main snap in (18),
a pivotably supported (32) blocking pawl (30) forms a further lock member, wherein the closure element (10) transfers the rotary catch (15) from an open position (15.1) while the flap (12) or door is half closed,
and wherein then the rotary catch (15) is further rotated (45) into a main locking position (15.3) while the flap or door is fully closed,
wherein the preliminary locking position (15.2) and the main locking position (15.3) of the rotary catch (15) is determined at the preliminary snap in or at the main snap in (18) based on the falling in of the blocking pawl (30),
and with several sensors (51 through 55) for different work positions of the lock member,
characterized in that two separate blocking pawls (20, 30) are coordinated to the rotary catch (15),
that is a first pawl (20), which first pawl (20) attacks only at the preliminary snap in (17) and therefore is a preliminary catch pawl (20),
and a second blocking pawl (30), which second blocking pawl (30) is pivotably supported (22) separately from the first pawl (20), which second pawl (30) only attacks at the main snap in (18) and which operates as main catch pawl (30),
and wherein at least two sensors (51 through 53) are furnished in the lock, and
wherein the one sensor (52) of the two sensors (51 through 53) directly or indirectly attacks at the main catch pawl (30) and therefore determines the fall in position (30.2) and/or the release position (30.1) of the main catch pawl (30) and therefore is a main catch sensor (52),
while the other sensor (51) directly or indirectly determines the fall in position (20.2) and/or the release position (20.1) of the preliminary catch pawl (20) and operates as a preliminary catch sensor (51).

2. Closure according to claim 1, wherein in each case a transfer lever is disposed between the preliminary catch sensor (51) and the preliminary catch pawl (20) and/or between the main catch sensor (52) and the main catch pawl (30)
and that the transition lever is pivotably supported in the lock and transfers the motion (28; 38) of the preliminary catch pawl (20) or of the main catch pawl (30) onto the associated sensor (51; 52).

3. Closure according to claim 1, wherein a release member is furnished in the lock for releasing the rotary catch (15), wherein the release member engages both at the main catch pawl (30) and as well as also at the preliminary catch pawl (20),
and wherein the two pawls (30,20) are simultaneously or timewise successively transferred into their release position (30.1, 20.1) upon actuation of the release member.

4. Closure according to claim 1, wherein the main catch pawl (30) and the preliminary catch pawl (20) are overlapping in certain regions,
and—in the case of actuation—in fact the release member attacks only at the one pawl (30 or 20), however indirectly controls also the other pawl (20 or 30) because of the overlapping.

5. Closure according to claim 1, wherein the two pawls (20, 30) run in the same sense or in an opposite sense relative to each other,
and wherein the pawls (20, 30) are either turned toward each other with their free ends and are directed away from each other with their two swivel axes (22,33),
or are directed away from each other with their free ends and are turned towards each other with their two swivel axes (22,33).

6. Closure according to claim 1, wherein the rotary catch (15) with its main snap in (18) supports itself at the main catch pawl (30) in the main locking position (15.3) and therewith the swivel bearing (32) of the main catch pawl (30) is pressure loaded,
while the preliminary catch pawl (20) grips behind the preliminary snap in (21) of the rotary catch (15) in the preliminary locking position (15.2) and the swivel bearing (22) of the rotary catch (15) is tension loaded.

7. Closure according to claim 1, wherein an opening help for motorized lifting out (28, 38) of the pawls (20; 30) from the rotary catch (15) attacks at least one of the two pawls (20; 30) and forms a motorized release member.

8. Closure according to claim 1, wherein the mechanical release member attacks at one of the two pawls, which mechanical release member upon actuation actuates at least one of the two pawls (20; 30).

9. Closure according to claim 1, wherein the blocking position (21) of the preliminary catch pawl (20) and the preliminary snap in (17) at the rotary catch (15) are simultaneously drive means of a motorized closure help (40) and with their motorized actuation (44) transfer the rotary catch (15) out of its preliminary locking position (15.2) into its main locking position (15.3).

10. Closure according to claim 9, wherein the closing help serves for motorized further rotation (45) of the rotary catch (13) (translators remark: should be (15)) and includes a work member (41), wherein the swivel bearing (22) of the preliminary catch pawl (20) is seated at the work member (41) and/or the swivel bearing (22) of the preliminary catch pawl is directly or indirectly taken along upon a motorized motion of the work member (41),
wherein upon the taking along the preliminary catch pawl (20) continues to turn (45) with its engagement (20.2) in the preliminary snap in (17) of the rotary catch (15),
and wherein the preliminary catch pawl (20), in addition to its first function to secure the preliminary locking position (15.2) of the rotary catch (15), has the further functions to operate as a carrier for further rotating (45) of the rotary catch (15) into its main locking position (15.3).

11. Closure according to claim 10, wherein the preliminary catch pawl (20) is releasable and disengageable in each phase of its motorized motion from the preliminary locking position (15.2) in its function as the closure help (40) and allows to open the door or flap (12) also in case of a failure of the motor.

12. Closure according to claim 9, wherein the work member is a rotary supported (42) work lever (41), and wherein the motor of the closure help (40) engages at the rotary supported (42) work lever (41),

13. Closure according to claim 12, wherein the working lever (41) has a spatially fixed rotation bearing (42).

14. Closure according to claim 13, wherein the rotary bearing (42) of the work lever (41) coincides axially with the rotation axis (14) of the rotary catch (15).

15. Closure according to claim 1, wherein a spatially fixed limit stop (46) is disposed in the lock next to the preliminary catch pawl (20),
wherein the preliminary catch pawl (20) supports itself at this limit stop (46) in case of a crash,
and wherein the swivel bearing (22) of the preliminary catch pawl (20) is disposed at the work lever (41) and becomes unloaded through this limit stop (46) in case of a crash.

16. Closure according to claim 1, wherein the same lock can be used alternatively in two different application situations
namely—according to a first case of application—as a servo lock with integrated closure help (40) with the use of the preliminary snap in (17) and the main snap in (18) of the rotary carriage (15),
or—according to a second case of application—as a standard lock without closure help (40), wherein the work member with the thereto associated swivel supported preliminary catch pawl (20) is dispensed with and only the main snap in (18) of the rotary catch (15) is used.

17. Closure according to claim 1, wherein the sensors (51 through 53) are connected to an electrical control apparatus,
and wherein the sensors (51 through 53) digitally inform the control apparatus with switch on and switch off signals (1; 0) about the closure status of the monitored lock members (20, 30,15).

18. Closure according to claim 17 wherein the signal (0) of the preliminary catch sensor (51) produced in the preliminary catch position (15.2) of the rotary catch (15) is not changed during further rotation of the rotary catch (15) up to the main locking position (15.3).

19. Closure according to claim 1, wherein a third sensor (53) engages at the rotary catch (15) and determines if the rotary catch (15) is disposed or it is not disposed in its main locking position (15.2),
and wherein this third sensor (53) operates as the so-called “snow load sensor”.

20. Closure according to claim 17, wherein the signal (1) of the main catch sensor (52) produced in the open position (15.1) of the rotary catch (15) is not changed upon further rotation of the rotary catch (15) up to shortly before the reaching of the main locking position (15.3).

21. Closure according to claim 17, wherein the signal (0) of the third sensor produced in the preliminary locking position (15.2) of the rotary catch (15) is not changed upon further rotating up to inclusive to the main locking position (15.3).

22. Closure according to, wherein the switch on and switch off signals (1; 0) of the sensors (51 through 53) in the preliminary locking position (15.2), in the main locking position (15.3) and possibly in the open position (15.1) of the rotary catch (15) determine three digital codes (0/1/0), (0/0/0), (1/1/1), which codes are different from each other.

23. Closure according to claim 22, wherein the control apparatus responds to the code change (36) between the open position code and the preliminary snap in code of at least one sensor (51,52) and therewith determines the exact preliminary locking position (15.2) of the rotary catch.

24. Closure according to claim 22, wherein the control apparatus responds to the code change (37) between the preliminary locking position code and the main catch code of the sensors (51 through 53) and therewith determines the exact main locking position (15.3) of the rotary catch (15).
